(19) United States
(12) Patent Application Publication
(10) Pub. No.: US 2004/0223506 A1
(43) Pub. Date: Nov. 11, 2004

(54) Packet communication device sending delayed acknowledgement through network

(75) Inventor: Go Sato, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., Tokyo (JP)

(21) Appl. No.: 10/431,460

(22) Filed: May 8, 2003

(51) Int. Cl. H04L 12/54

(52) U.S. Cl. 370/428; 370/252; 714/748

(57) ABSTRACT

A switching function determines whether to use delayed acknowledgment in following processing on the basis of whether received data is a “successive” or “non-successive” type of data. That is, when the type of the received data is “successive,” delayed acknowledgment is basically used in the processing. On the other hand, when the type of the received data is “non-successive,” delayed acknowledgment is basically not used. When the received data is “non-successive,” a normal receiving processing is performed according to TCP.

### BACKGROUND OF THE INVENTION

1. Field of the Invention

The present invention relates to communications techniques, and particularly to communications techniques that adopt TCP (Transmission Control Protocol).

2. Description of the Background Art

FIG. 14 is a conceptual diagram illustrating acknowledgments according to TCP. In a communications technique that adopts TCP, when a receiving host 102 receives packets D1, D2, D3 from a sending host 101, the receiving host 102 correspondingly sends acknowledgments A1, A2, A3 back to the sending host 101. This allows the sending host 101 to recognize that the packets D1, D2, D3 have arrived at the receiving host 102, thereby ensuring reliability. However, when many packets are sent in a short period of time, closely sending many acknowledgments increases traffic.

Thus, RFCs (Request For Comment) regarding TCP suggest delayed acknowledgments (RFC 1122: Delayed Acknowledgment, RFC 813: Acknowledgment Delay). FIG. 15 is a conceptual diagram illustrating the delayed acknowledgments. In this technique, the receiving host 102 does not send an acknowledgment every time it receives a packet. That is, after receiving one packet D1, the receiving host 102 stands by for a given time period; when the receiving host 102 receives a new packet D2 within the standby time, it sends to the sending host 101 an acknowledgment A12 corresponding to the packets D1 and D2. Similarly, the receiving host 102 sends to the sending host 101 an acknowledgment A34 corresponding to packets D3 and D4 and an acknowledgment A56 corresponding to packets D5 and D6.

FIG. 16 is a conceptual diagram that shows a problem of the delayed acknowledgment. When the receiving host 102 uses delayed acknowledgment, it stands by for a given standby period after receiving the packet D1. If the receiving host 102 does not receive packet D2 within the standby period, it sends an acknowledgment A11 to the sending host 101 without waiting till the packet D2 is received, so as to allow the sending host 101 to recognize that the receiving host 102 has received the packet D1. As compared with the acknowledgment A1 that would be sent when delayed acknowledgment is not used, the acknowledgment A11 causes a delay time Δbefore allowing the sending host 101 to recognize the reception of packet D1 at the receiving host 102.

When many packets are received from the sending host 101 in a short time, the use of delayed acknowledgments reduces the traffic. However, the communications rate is lowered if the packet D2 following the packet D1 is not received within the given standby time after the receipt of the packet D1.

Thus, depending on the packets sent from the sending host 101, communications may actually be more efficient when the delayed acknowledgment is not used. However, conventionally, the delayed acknowledgment is applied equally to all packets, lowering communications rate in some cases.

### SUMMARY OF THE INVENTION

An object of the present invention is to automatically control whether to adopt delayed acknowledgment. Another object of the invention is to prevent a reduction of communications rate by reducing unnecessary delays even when the delayed acknowledgment is adopted.

In the present invention, a packet communication device includes: decision means for deciding contents of a packet received from a network; and switching means for determining whether to adopt delayed acknowledgment on the basis of a decision made by the decision means.

When there is no need to immediately send an acknowledgment in response to a packet, the packet communication device waits for the next packet. On the other hand, when a packet requires transmission of an acknowledgment, the packet communication device sends an acknowledgment. It is then possible to avoid an increase in traffic and also to prevent a reduction of communications rate due to standby time for the delayed acknowledgment.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram of the hierarchical structure of a communication protocol that is applied to a packet communication device of a first preferred embodiment of the invention;

FIG. 2 is a block diagram illustrating the structure of the packet communication device of the first preferred embodiment;

FIG. 3 is a flowchart showing operation of the first preferred embodiment;

FIG. 4 is a conceptual diagram showing a first specific example of the operation of the first preferred embodiment;

FIG. 5 is a conceptual diagram showing a second specific example of the operation of the first preferred embodiment;

FIG. 6 is a conceptual diagram showing a third specific example of the operation of the first preferred embodiment;

FIG. 7 is a conceptual diagram showing a fourth specific example of the operation of the first preferred embodiment;

FIG. 8 is a conceptual diagram showing part of the hierarchical structure of a communication protocol that is applied to a packet communication device of a second preferred embodiment of the invention;

FIG. 9 is a conceptual diagram showing the structure of data Q that is given from IP layer 3 to TCP layer 2;

FIG. 10 is a flowchart showing part of the processing of a fourth preferred embodiment of the invention;

FIG. 11 is a flowchart showing a modification of the fourth preferred embodiment;

FIG. 12 is a flowchart showing part of the processing of a fifth preferred embodiment of the invention;

FIG. 13 is a flowchart showing a modification of the fifth preferred embodiment; and

FIGS. 14 to 16 are conceptual diagrams showing conventional techniques.

### DESCRIPTION OF THE PREFERRED EMBODIMENTS

First Preferred Embodiment

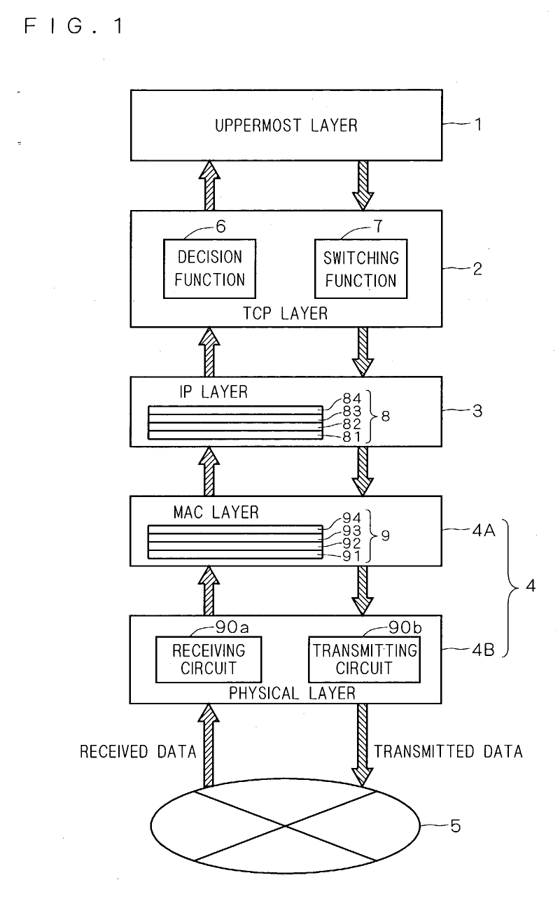

FIG. 1 is a conceptual diagram of the hierarchical structure of a communications protocol that is applied to a packet communication device of a first preferred embodiment of the invention. The uppermost layer 1 is placed the most distant from the network 5, and a TCP layer 2, an IP (Internet Protocol) layer 3, a MAC (Media Access Control) layer 4A, and a physical layer 4B are arranged in this order toward lower level in the hierarchy, or toward the network 5. Each layer receives data from a layer below (the data includes those in which given headers have been removed from packets), and each layer sends data to the layer below. FIG. 1 shows received data and sent data with right-side-up- and right-side-down-hatched arrows, respectively.

When these layers are compared with those of the OSI (Open System Interconnection) reference protocol, the uppermost layer 1 corresponds to the application, presentation, and session layers, and the TCP layer 2, IP layer 3, MAC layer 4A, and physical layer 4B respectively correspond to the transport layer, network layer, data link layer, and physical layer. At least part of the physical layer 4B, i.e. the part directly connected to the network 5 or physical circuitry, includes as hardware a receiving circuit 90a for receiving packets from the network 5 as electric signal and a transmitting circuit 90b for transmitting packets onto the network 5 as electric signal. The MAC layer 4A and the physical layer 4B may be regarded together as a data link layer 4.

The TCP layer 2 includes, in addition to conventional TCP functions, a decision function 6 and a switching function 7 as will be described later; for convenience, FIG. 1 shows these functions as blocks. Note that means for realizing the decision function 6 and switching function 7 may be provided in a TCP communication device. The IP layer 3 serves to temporarily store data received from the MAC layer 4A; for convenience, FIG. 1 shows this as a buffer 8 with a block. The MAC layer 4A serves to temporarily store data received from the physical layer 4B; for convenience, FIG. 1 shows this as a buffer 9 with a block. Note that means offering the functions of the buffers 8 and 9 may be provided in the TCP communication device.

The buffers 8 and 9 may store a plurality of pieces of data that are sequentially received. For example, the buffer 8 has buffer elements 81 to 84 each temporarily storing one packet, and the buffer 9 has buffer elements 91 to 94 each temporarily storing one packet. The buffer elements 81, 82, 83, 84 and the buffer elements 91, 92, 93, 94 are arranged respectively in the named orders, away from the network 5 or toward the uppermost layer 1.

These functions shown as blocks are not necessarily realized with specialized circuits that provide these functions; the functions can be realized as software that operates in general-purpose computers.

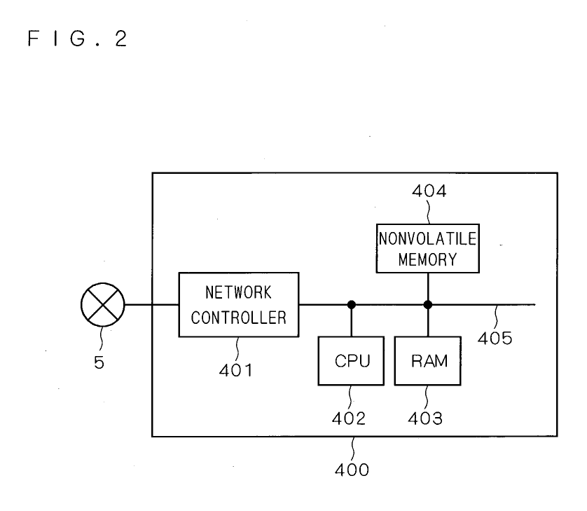

FIG. 2 is a block diagram illustrating a packet communication device 400 that adopts a communications protocol having the hierarchical structure shown in FIG. 1. The communication device 400 includes a network controller 401, a CPU (Central Processing Unit) 402, a RAM (Random Access Memory) 403, and a nonvolatile memory (e.g. a read-only memory) 404. For example, they are constructed as LSIs on separate chips and are interconnected through an internal bus 405. The RAM 403 and the nonvolatile memory 404 may be contained in the CPU 402.

The network controller 401 (or a specialized IC) realizes the physical layer 4B and MAC layer 4A in the block 4 shown in FIG. 1. The receiving circuit 90a, transmitting circuit 90b, and buffer 9 are contained in the network controller 401.

The uppermost layer 1, TCP layer 2, and IP layer 3 shown in FIG. 1 are realized as software. The CPU 402 reads programs from the nonvolatile memory 404 through the internal bus 405 and executes them. The functions of the uppermost layer 1, TCP layer 2, and IP layer 3, including the decision function 6 and switching function 7, are realized in this way. The RAM 403, that can be accessed by the CPU 402, serves as the buffer 8 in the IP layer 3.

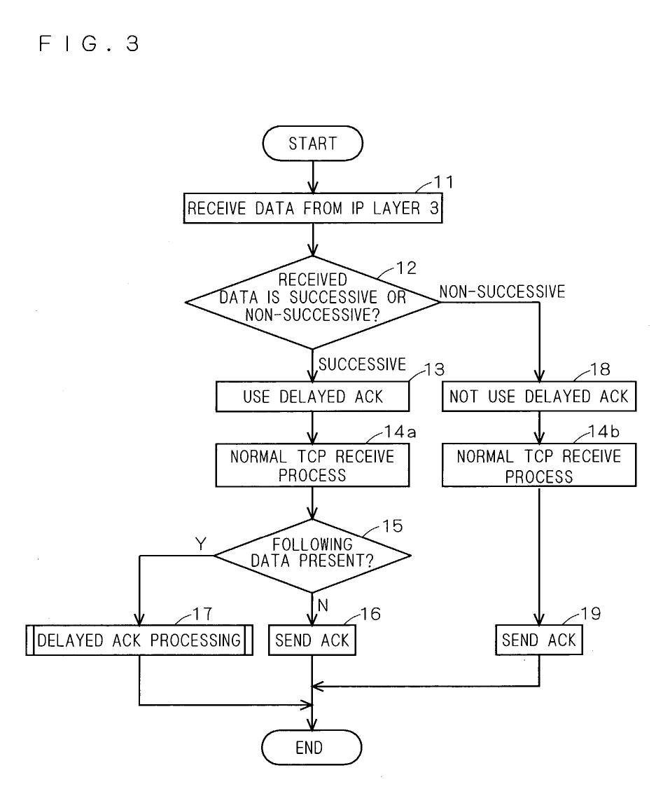

FIG. 3 is a flowchart showing operation of the first preferred embodiment of the invention. This flowchart shows the operation that is performed between the receipt of a packet and the transmission of an acknowledgment, which is executed as a function of the TCP layer 2. At step 11, data is received from the IP layer 3. This step 11 is performed each time a packet is received from the network 5 and after the data is transferred sequentially through the physical layer 4B, MAC layer 4A, and IP layer 3. After the execution of step 11, at step 12, the TCP layer 2 checks the received data to see its type. That is to say, the TCP layer 2 makes the decision of step 12 using the decision function 6.

Specifically, for example, a TCP port number contained in a header of the received data is referred to, so as to specify the application that should handle that data in the uppermost layer 1. When the application has been specified, it is then possible to decide from features of that application whether data will be received successively or non-successively. For example, if the port number is 21, then the application is FTP (File Transfer Protocol) and the data is received successively. When the port number is 23, then the application is TELNET (TELecommunication NETwork) and the data is received non-successively. Other examples of applications for which data is successively received include SMTP (Simple Mail Transfer Protocol) and POP3 (Post Office Protocol Version 3) which correspond to port numbers 25 and 110, respectively. Applications can thus be specified easily by referring to the port numbers, especially when the specified port numbers are well known.

Now, the packet to which data of the successively received type belongs employ a communications protocol which does not assume that sending and receiving hosts send/receive packets alternately. The packet to which data of the non-successively received type belongs employ a communications protocol which assumes that sending and receiving hosts alternately send/receive packets with each other. In the latter case, when a first host sends two packets #1 and #2 to a second host in this order, a packet #3 is sent from the second host to the first host between the transmission of packet #1 and the transmission of packet #2.

On the basis of the decision made by the decision function 6, i.e. on the basis of whether the received data is “successive” or “non-successive” type of data, the switching function 7 determines whether to use delayed acknowledgment in following processing. That is to say, when the received data is “successive,” then the flow moves to step 13 where a decision is made to basically use the delayed acknowledgment. On the other hand, when the received data is “non-successive,” then the flow moves to step 18 to decide not to use the delayed acknowledgment basically. FIG. 3 shows acknowledgment as ACK.

When the decision shows that the type of the received data is “non-successive,” the flow proceeds to step 14b to perform a normal receiving processing according to TCP. Then, at step 19, an acknowledgment is sent to the sending host and the processing from the packet reception to acknowledgment is ended.

When the decision shows that the type of the received data is “successive,” the flow proceeds to step 14a to perform a normal receiving processing according to TCP. Next, at step 15, the decision function 6 decides whether data follows the data received in step 14a.

The decision function 6 checks the data which is stored in the buffer 8 in the IP layer 3 and which will be transferred to the TCP layer 2 immediately next (hereinafter referred to as immediately following buffered data). If the immediately following buffered data is data that conforms to TCP, then it is decided that data which follows the data processed in step 14a is present. On the basis of this decision, the switching function 7 determines to adopt the delayed acknowledgment. Then the flow moves to step 17 to perform a delayed acknowledgment processing. On the other hand, when it is decided that no immediately following buffered data is present, or when the immediately following buffered data is data that conforms to a protocol other than TCP, then the switching function 7 determines, on the basis of the decision, to send an acknowledgment without adopting the delayed acknowledgment. On the basis of this determination, the flow proceeds to step 16 to send an acknowledgment.

It can be said that the decision made in step 15 is checking to see whether following data is present or absent; the “following data” means data which has been already obtained from a packet and which will be received next conforming to the same protocol as the data received at a protocol layer corresponding to the transport layer (shown as TCP layer 2 in FIG. 1).

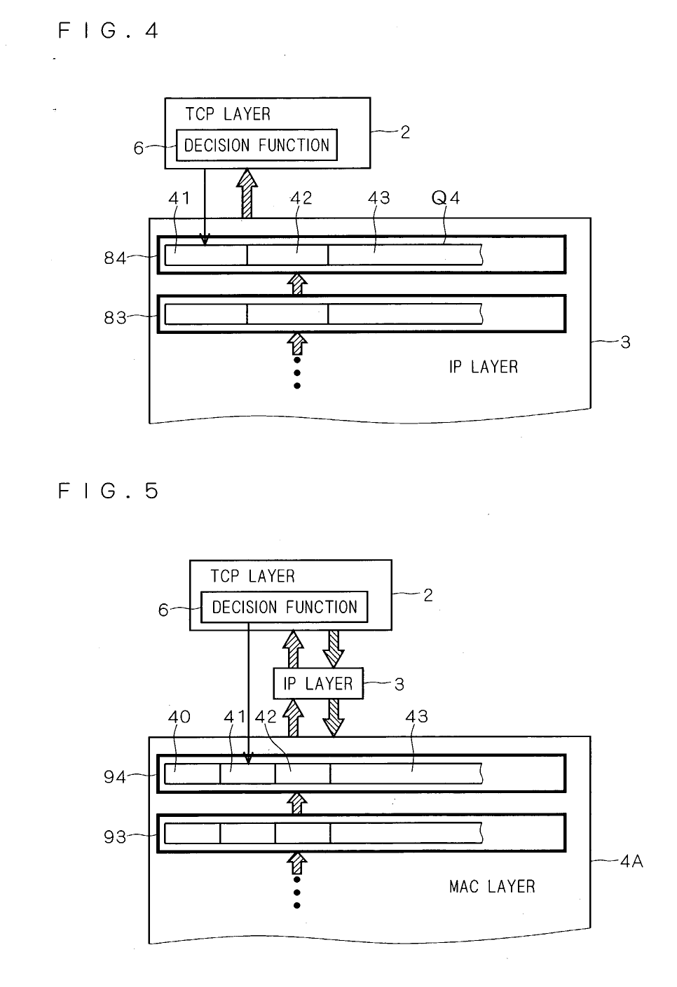

Specifically, for example, the decision of step 15 is made as shown below. FIG. 4 is a conceptual diagram showing a first specific example that illustrates the decision of step 15 is made. The immediately following buffered data Q4, or the packet stored in the buffer 84 in the IP layer 3, includes an IP header 41, a transport layer header 42, and transport layer data 43.

In general, a header regarding the network layer includes data that shows which protocol the packet to which the header belongs conform to at the transport layer. For example, the IP header 41 includes a protocol number which will be described in a second preferred embodiment. The protocol number shows whether the data has been obtained from a packet that adopts TCP as the transport-layer protocol (TCP segment), or obtained from a packet that conforms to another protocol, e.g. UDP (User Datagram Protocol: UDP datagram). For example, when the immediately following buffered data Q4 is data obtained from a TCP segment, the transport layer header 42 and the transport layer data 43 are a TCP header and TCP data, respectively. When the immediately following buffered data Q4 is a UDP datagram, then the transport layer header 42 and transport layer data 43 are a UDP header and UDP data, respectively.

FIG. 5 is a conceptual diagram showing a second specific example that illustrates the decision of step 15. Here the IP header 41 of data temporarily stored in the buffer 9 in the MAC layer 4A is checked. Data received at a protocol layer that corresponds to the network layer (the IP layer 3 herein) or a protocol layer still closer to the network (the MAC layer 4A herein) includes a header about the protocol layer corresponding to the network layer (the IP header 41 herein), and that header contains data for specifying the protocol at the transport layer (e.g. the TCP layer 2). Therefore it is also possible to decide whether the packet is a TCP segment or data of other type, e.g. a UDP datagram, by checking the IP header 41 of the data temporarily stored in the buffer 9.

Note that the data stored in the buffer 9 includes, as headers, a data link layer header 40 (e.g. an Ethernet (trademark) header, etc.) as well as the IP header 41 and transport layer header 42.

As shown above, whether or not data that conforms to the same protocol as the data received at the TCP layer 2 will be received in succession can be decided by checking the IP header 41 of data received at the IP layer 3 or the MAC layer 4A that is still closer to the network 5 than the IP layer 3.

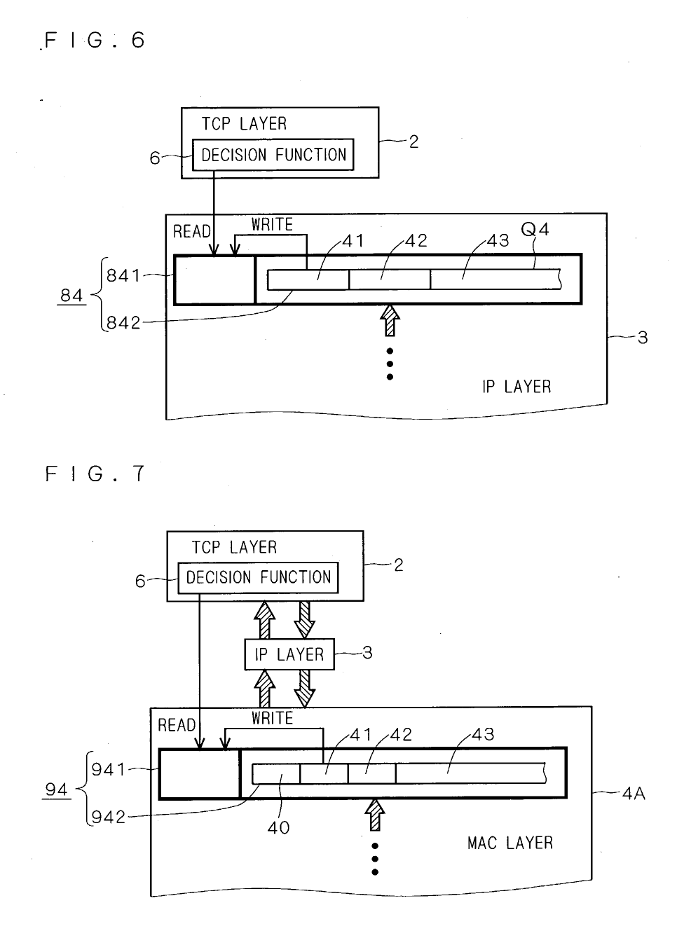

FIG. 6 is a conceptual diagram showing a third specific example that illustrates the decision of step 15. Here, the buffer 8, e.g. the buffer element 84, includes a flag region 841 and a storage region 842 for storing immediately following buffered data Q4. As mentioned above, the IP header 41 contains information showing what is adopted as the transport-layer protocol for the data to which the IP header 41 belongs. Therefore the IP layer 3 can analyze the IP header 41 so as to write a flag in the flag region 841 to show whether TCP is adopted as the transport-layer protocol. From the TCP layer 2, the decision function 6 can read the flag region 841 to make the decision of step 15.

FIG. 7 is a conceptual diagram showing a fourth specific example that illustrates the decision of step 15, where the third specific example is applied to the second specific example shown in FIG. 5. The buffer 9 includes a flag region 941 and a storage region 942. Then the MAC layer 4A can analyze the IP header 41 so as to write a flag in the flag region 941 to show whether TCP is adopted as the transport-layer protocol. From the TCP layer 2, the decision function 6 can read the flag region 941 to make the decision of step 15.

The flag region is not necessarily provided in the buffer 8 or buffer 9; that flag may be adopted as a global variable.

Referring to FIG. 3 again, when step 15 decides that following data is present and the flow proceeds to step 17, then a delayed acknowledgment processing is done. More specifically, when the TCP layer 2 has received data only once after the transmission of the previous acknowledgment, the processing ends without sending an acknowledgment. After that, the process waits for the reception of immediately following buffered data Q4 at the IP layer 3 (or data in which the IP header 41 has been removed from the immediately following buffered data Q4). When the TCP layer 2 has received data given multiple times after the transmission of the previous acknowledgment, then an acknowledgment is sent and the flow ends. Or, even when the TCP layer 2 has not received data for the given multiple times after the transmission of the previous acknowledgment, an acknowledgment is sent when a given standby time has passed after the reception of the last data, and then the flow ends. This given multiple times is set to be twice, for example.

When step 15 decides that no following data is present, the flow moves to step 16, where an acknowledgment is soon sent to the sending host and the processing from the packet reception to acknowledgment is ended.

As described above, according to the packet communication device of this preferred embodiment, in step 12, the decision function 6 checks the contents of a packet, e.g. to decide the application by which the packet is processed. Then the switching function 7 determines whether to adopt the delayed acknowledgment. Then, when the packet does not require immediate transmission of an acknowledgment, the packet communication device can wait for the next packet; when the packet requires immediate transmission of an acknowledgment, then the device can send an acknowledgment. It is then possible to avoid an increase in traffic and also to prevent communications rate reduction caused by the standby time for delayed acknowledgment.

Furthermore, in the packet communication device of this preferred embodiment, even when the delayed acknowledgment is adopted, step 15 checks whether the following data is present or absent, and on the basis of the decision, whether to immediately send an acknowledgment is determined. Accordingly, the standby time for delayed acknowledgment is not adopted when following data is absent, which prevents reduction in the communications rate. Thus, even when steps 12, 18, 14b and 19 are not performed, and therefore without checking whether data is “successive” or “non-successive,” i.e. without deciding the application that handles the data, the steps 15, 16 and 17 offer the above-described effects. In other words, the effect of switching the processing on the basis of the decision of step 12 and the effect of switching the processing on the basis of the decision of step 15 are not directly related but are independent of each other.

While this preferred embodiment checks whether following data is present or absent as the decision of the contents of packets, the third and following preferred embodiments show examples in which the contents of packets are checked on other criteria.

Second Preferred Embodiment

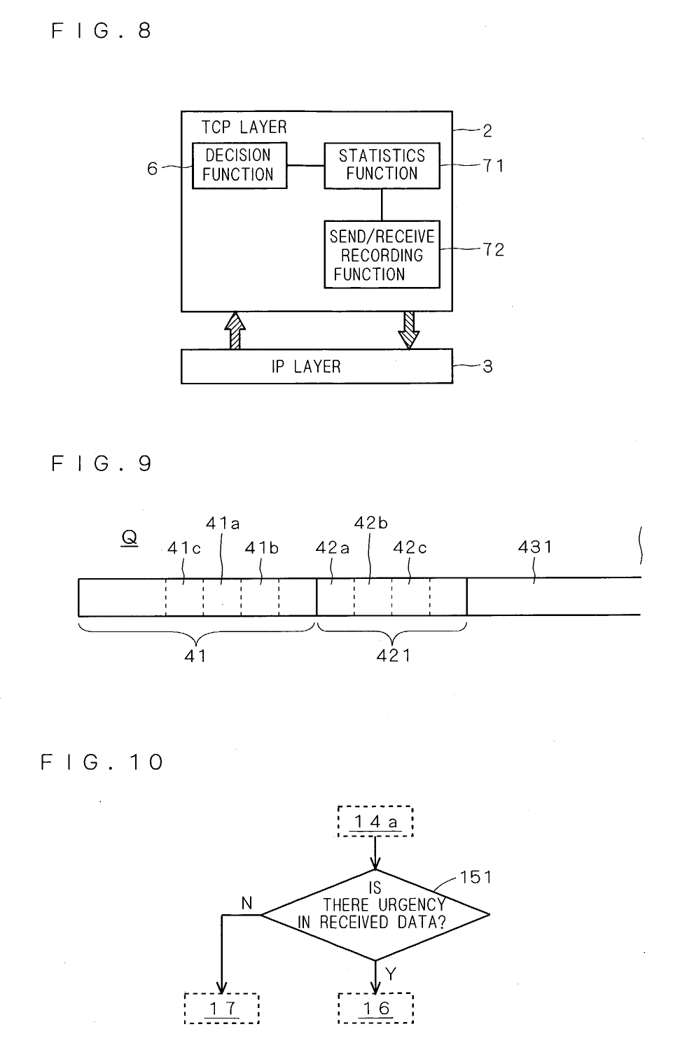

FIG. 8 is a conceptual diagram showing part of the hierarchical structure of a communications protocol that is applied to a packet communication device according to a second preferred embodiment of the present invention. FIG. 8 only shows the TCP layer 2 and the IP layer 3, and other layers can be configured as shown in FIG. 1.

The TCP layer 2 further includes a statistics function 71 and a send/receive recording function 72 as well as the decision function 6. FIG. 8 shows these functions as blocks for convenience. Note that means providing the statistics function 71 and the send/receive recording function 72 may be provided in the TCP communication device.

The send/receive recording function 72 records TCP connections included in the contents of the packets of data received from the IP layer 3. On the basis of the TCP connections recorded by the send/receive recording function 72, the statistics function 71 performs statistical processing as described below.

FIG. 9 is a conceptual diagram showing the structure of data Q that is given from the IP layer 3 to the TCP layer 2. The data Q is data that is processed according to TCP, which includes the IP header 41, TCP header 421, and TCP data 431. The TCP header 421 and TCP data 431 correspond to the transport layer header 42 and transport layer data 43 shown in FIG. 4, respectively.

The IP header 41 contains a source IP address 41a, a destination IP address 41b and a protocol number 41c, and the TCP header 421 contains a source port number 42a and a destination port number 42b. Since the data Q is processed according to TCP herein, the protocol number 41c is set at “6.”

The TCP connection is determined by the source IP address 41a, destination IP address 41b, source port number 42a and destination port number 42b. The send/receive recording function 72 records these four. The statistics function 71 collects statistics as to whether data received at the TCP layer 2 is “successive” or “non-successive,” as to the TCP connections determined by the contents stored by the send/receive recording function 72.

When the TCP layer 2 receives data from the IP layer 3, it checks the TCP connection of that data. Then the TCP layer 2 refers to the statistics function 71 for the TCP connection to see whether the statistics about that TCP connection shows that “successive” data outnumbers “non-successive” data or “non-successive” data outnumbers “successive” data. Then, when the statistics show that “successive” data outnumbers “non-successive” data with that TCP connection, then the flow moves from step 12 to step 13. On the other hand, when the statistics show that “non-successive” data outnumbers “successive” data with that TCP connection, then the flow moves from step 12 to step 18.

As shown above, this preferred embodiment obtains statistics showing which of “successive” data and “non-successive” data has been communicated more as to the TCP connection of received data and determines whether to adopt the delayed acknowledgment on the basis of the statistics. It is then possible to properly determine whether to adopt the delayed acknowledgment when the application cannot be specified from the port number, e.g. when an originally created application is adopted.

Third Preferred Embodiment

As shown in FIG. 9, the TCP header 421 further includes code bits 42c. The decision of step 15 shown in FIG. 1 may be made on the basis of the code bits 42c. The code bits 42c may be referred to by accessing the buffer 8 or buffer 9 from the TCP layer 2 as described in the first preferred embodiment. Alternatively, the TCP layer 2 may refer to the code bits 42c in data it has received.

In this preferred embodiment, the TCP layer 2 refers to a push flag PSH usually provided in the code bits 42c, e.g. using the decision function 6 contained in the TCP layer 2, so as to decide whether following data is present or absent. When the bit provided as the push flag PSH is active (e.g. when the value is 1), it shows a break of data. That is, when the push flag PSH is active “1,” then following data is likely to be absent.

Accordingly, in this preferred embodiment, when the push flag PSH is “1”, then the switching function 7 determines to immediately send an acknowledgment without adopting the delayed acknowledgment. Thus the flow proceeds from step 15 to step 16 to immediately send an acknowledgment. When the push flag PSH is 0, then the switching function 7 determines to adopt the delayed acknowledgment. Then the flow proceeds from step 15 to step 17 to perform a delayed acknowledgment processing. Thus, when it is likely that following data will be absent, the standby time for delayed acknowledgment is not adopted, thereby preventing the reduction of communications rate.

Fourth Preferred Embodiment

FIG. 10 is a flowchart showing part of the processing of a fourth preferred embodiment of the invention. The step 15 in the flowchart of FIG. 3 is replaced by a step 1; as to other steps, those shown in FIG. 3 can be adopted.

In this preferred embodiment, the TCP layer 2 refers, e.g. using the decision function 6 provided therein, to an urgent flag URG usually contained in the code bits 42c. When the bit provided as the urgent flag URG is active (e.g. when the value is “1”), it indicates urgency. When step 151 shows that the urgent flag URG is “1,” the switching function 7 then determines to immediately send an acknowledgment without adopting the delayed acknowledgment. Then the flow proceeds from step 151 to step 16. When the urgent flag URG is “0,” then the switching function 7 determines to adopt the delayed acknowledgment and moves to step 17. Thus, when there is urgency, acknowledgments can be quickly sent without adopting the standby time for delayed acknowledgment, preventing reduction of communications rate.

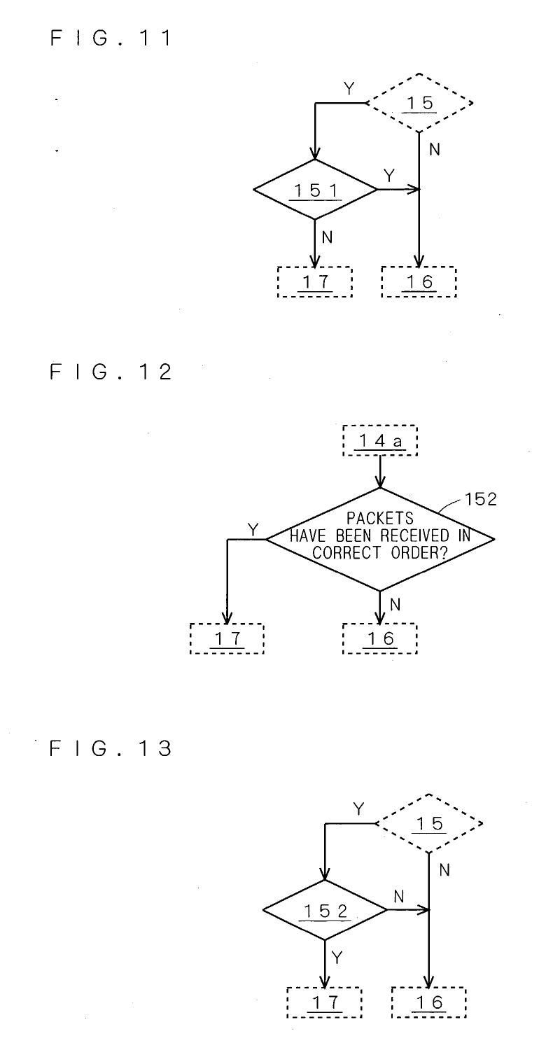

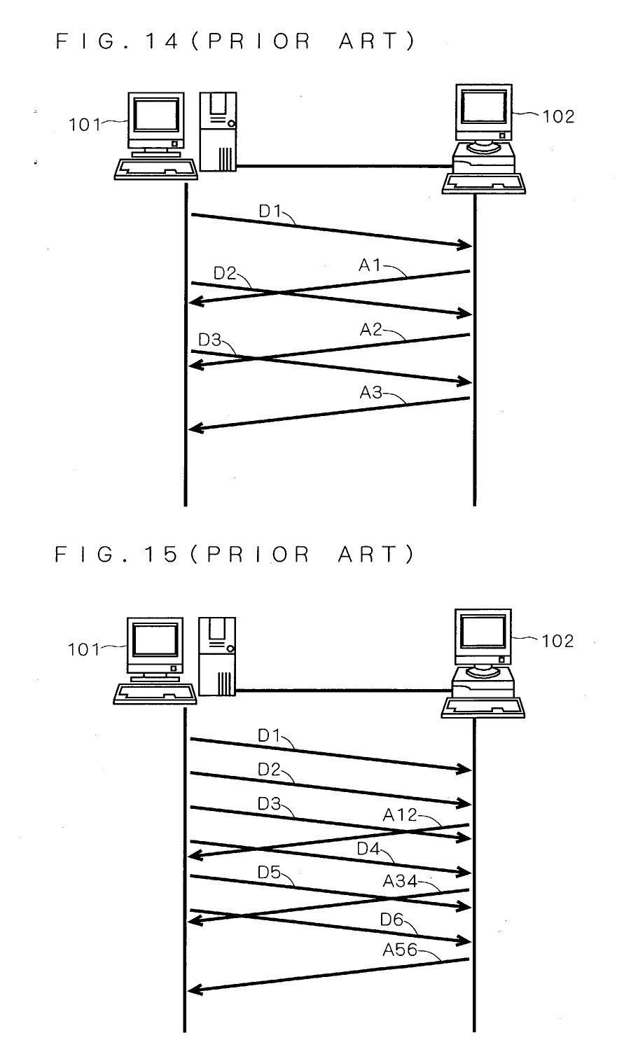

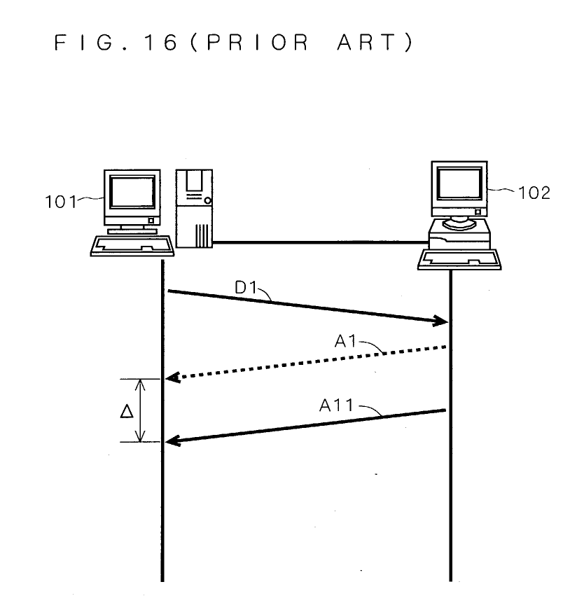

FIG. 11 is a flowchart showing a modification of this preferred embodiment. The step 151 is inserted between the steps 15 and 17 in the flowchart of FIG. 3; as to other steps, those shown in FIG. 3 can be adopted.

When step 151 decides that there is an urgency in data, the flow proceeds to step 16 even if step 15 decides that there is the following data. This process flow allows acknowledgments to be immediately sent when there is urgency, regardless of whether following data is present or absent.

Fifth Preferred Embodiment

FIG. 12 is a flowchart showing part of the processing of a fifth preferred embodiment of the invention. The step 15 in the flowchart of FIG. 3 is replaced by a step 152; other steps shown in FIG. 3 can be adopted.

In this preferred embodiment, the TCP layer 2 checks, e.g. using the decision function 6, to see whether a packet has been received in the correct order. When the packet is not received in the correct order, TCP segments may have been lost during transmission, so that an acknowledgment must be quickly sent to the sender. Accordingly, when the decision shows that the packet is not in the correct order, the switching function 7 determines to immediately send an acknowledgment without adopting delayed acknowledgment. Thus the flow moves from step 152 to step 16 to immediately send an acknowledgment to the sender. On the other hand, when the decision shows that the packet is in the correct order, the switching function 7 determines to adopt the delayed acknowledgment. Thus the flow proceeds from step 152 to step 17 to perform a delayed acknowledgment processing.

FIG. 13 is a flowchart showing a modification of this preferred embodiment. The step 152 is inserted between the steps 15 and 17 of the flowchart of FIG. 3; other steps of FIG. 3 can be adopted.

When step 152 decides that the packet is not received in the correct order, the flow moves to step 16 even when step 15 shows the present of following data. That is to say, when the decision of step 15 shows the presence of the following data and the packet has been received in the correct order, then a delayed acknowledgment processing is performed at step 17. On the other hand, when the decision shows the absence of following data, or when the packet has not been received in the correct order, an acknowledgment is quickly sent at step 16. This processing flow allows acknowledgments to be immediately sent when received packet is not in the correct order, regardless of whether following data is present or absent.

The TCP layer 2 may decide whether a packet has been received in the correct order on the basis of sequence numbers or acknowledgment numbers normally contained in the TCP headers.

While the description above has shown examples that adopt the TCP protocol, the invention can be applied also when other protocols of a so-called connection type which use acknowledgments are adopted.

The protocol in the MAC layer 4A may be IEEE802.3 or Ethernet (trademark) II. Not only the IP layer but also an NCP (Netware Core Protocol) layer may be adopted as layers corresponding to the network layer of the OSI reference protocol, and an LCP (Link Control Protocol) layer may be adopted in place of the MAC layer 4A as the layer corresponding to the data link layer of the OSI reference protocol. In this case, PPP (Point-to-Point Protocol) may be adopted as the protocol (thus the NCP mentioned above is for PPP but not for ARPANET (Advanced Research Projects Agency NETwork).

While the invention has been described in detail, the foregoing description is in all aspects illustrative and not restrictive. It is understood that numerous other modifications and variations can be devised without departing from the scope of the invention.

What is claimed is:

1. A packet communication device comprising:
decision means for deciding contents of a packet received from a network; and
switching means for determining whether to adopt delayed acknowledgment on the basis of a decision made by said decision means.

2. The packet communication device according to claim 1, wherein said decision means specifies an application that handles said packet and said switching means determines whether to adopt the delayed acknowledgment on the basis of said application.

3. The packet communication device according to claim 2, wherein said application is specified on the basis of a port number of said packet.

4. The packet communication device according to claim 1, wherein a communications protocol of said packet is decided on the basis of a source address, a destination address, a source port number, and a destination port number of said packet.

5. The packet communication device according to claim 4, further comprising:
send/receive recording means for recording said source address, said destination address, said source port number, and said destination port number; and
statistics means for collecting statistics about a history of communications with said source address, said destination address, said source port number, and said destination port number;
wherein said switching means determines whether to adopt said delayed acknowledgment on the basis of said statistics.

6. The packet communication device according to claim 1,
wherein said decision means decides whether there is following data which has been already obtained from said packet and which conforms to a same protocol as data received at a protocol layer corresponding to a transport layer and which will be received following that data, and
said switching means determines to adopt said delayed acknowledgment when said decision means decides that said following data is present, and otherwise said switching means determines to immediately send acknowledgment.

7. The packet communication device according to claim 6,
wherein said packet is a TCP segment,
and wherein when said decision means decides that said following data is present, said switching means determines to adopt said delayed acknowledgment except when an urgent flag included among code bits in a TCP header of said packet is active, and
when said decision means decides that said following data is absent, or when said urgent flag is active, said switching means determines to immediately send acknowledgment.

8. The packet communication device according to claim 6, wherein when said decision means decides that said following data is present, and said packet has been received in a correct order, then said switching means determines to adopt said delayed acknowledgment, and
when said decision means decides that said following data is absent or when said packet has not been received in a correct order, then said switching means determines to immediately send acknowledgment.

9. The packet communication device according to claim 6, wherein said decision means checks data that has been received at a protocol layer that corresponds to a network layer or at a protocol layer that is placed closer to a network than said protocol layer.

10. The packet communication device according to claim 9, wherein said decision means checks a header about said protocol layer corresponding to the network layer.

11. The packet communication device according to claim 1,
wherein said packet is a TCP segment, and
wherein said decision means checks a push flag included among code bits in a TCP header of said packet, and
said switching means determines to immediately send said acknowledgment when said push flag is active, and determines to adopt said delayed acknowledgment when said push flag is not active.

12. The packet communication device according to claim 11,
wherein said packet is a TCP segment, and
wherein when said decision means decides that said following data is present, said switching means determines to adopt said delayed acknowledgment except when an urgent flag included among code bits in a TCP header of said packet is active, and when said decision means decides that said following data is absent or when said urgent flag is active, said switching means determines to immediately send acknowledgment.

13. The packet communication device according to claim 11, wherein when said decision means decides that said following data is present, and said packet has been received in a correct order, then said switching means determines to adopt said delayed acknowledgment, and
when said decision means decides that said following data is absent or when said packet has not been received in a correct order, then said switching means determines to immediately send acknowledgment.

14. The packet communication device according to claim 1, wherein said packet is a TCP segment,
and wherein said switching means determines to adopt delayed acknowledgment except when an urgent flag included among code bits in a TCP header of said packet is active, and
said switching means determines to immediately send acknowledgment when said urgent flag is active.

15. The packet communication device according to claim 1, wherein said switching means determines to immediately send acknowledgment when said packet has not been received in a correct order.
